(19) United States
(12) Patent Application Publication
(10) Pub. No.: US 2024/0092411 A1
(43) Pub. Date: Mar. 21, 2024

(54) Motorized Handcart Backpack

(71) Applicant: Blake Graham, Colorado Springs, CO (US)

(72) Inventor: Blake Graham, Colorado Springs, CO (US)

(21) Appl. No.: 17/945,903

(22) Filed: Sep. 15, 2022

(51) Int. Cl. B62B 5/06; B62B 1/18; B62B 5/00

(52) U.S. Cl. CPC B62B 5/068; B62B 1/18; B62B 5/004

(57) ABSTRACT

The disclosure is the only product of its kind that is equipped with an easily controllable motorized trailing bicycle wheel that rests on a backpack frame that can be conveniently worn by a hiker. This unprecedented product is uniquely designed with an integrated splash guard to protect the pack and its contents from natural debris and/or weather conditions, a saddlebag configuration to increase capacity, compartmentalization of the carry pack to prevent shifting loads, integrated cables to raise and lower the end attached to the hiker backpack frame, and handheld speed control and brake mechanisms with a built-in dead-man switch, all of which, serves to simplify the transport of supplies for professional or laymen hikers, alike, while also serving as a carry-all medium for any occasion such as: walking around town, attending a farm, a tradeshow, and a host of other activities that may appeal to consumers.

### BACKGROUND

When engaged in hiking activities, many will carry a heavy backpack full of essential supplies; yet, it can be incredible challenging and exhausting to hold these items in route. Moreover, carrying excessive weight in a backpack, for long periods of time, can cause wear-and-tear on the joints, ligaments, and muscles across the entire back and hips, for the carrier which defeats the joy of hiking. There have been no products available as original equipment or as an aftermarket to address this problem.

An apparatus to help ease the load of a traditional hiking backpack is not being met by any known device or system at present. There have been no products available as original equipment or as an aftermarket to address this problem either.

### SUMMARY OF THE INVENTION

A handcart comprising a pair of two wheels each comprising a motorized electric hub, a support frame attached to the pair of two wheels, a backpack frame attached to the support frame and a speed and brake controller attached to each of the motorized electric hubs.

The speed and brake controller enables braking the pair of two wheels via a step assisted detection a person wearing the backpack frame has stopped stepping. The speed and brake controller also enables a proportional braking the pair of two wheels to a step assisted detection a person wearing the backpack frame has slowed stepping. The speed and brake controller furthermore senses a linear force applied parallel to a travel surface on the handcart and provides an electric torque on each of the pair of wheels proportional thereto via each of the motorized electric hubs.

The speed of each of the motorized electric hubs is set separately by the speed and brake controller to allow a turning of the handcart under a control of the speed and brake controller and the person wearing the backpack frame. The speed of each of the motorized electric hubs is proportional to a step size and step frequency of a person wearing the backpack frame.

### BRIEF DESCRIPTION OF THE DRAWINGS

FIG. 1 is a back elevational view of the wheeled hiking backpack in accordance with an embodiment of the present disclosure.

FIG. 2 is a side elevational view of the wheeled hiking backpack in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

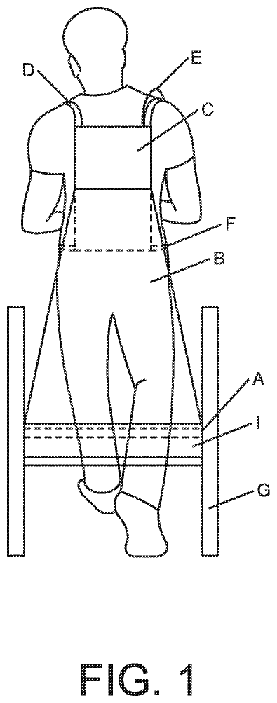

FIG. 1 is a back elevational view of the wheeled hiking backpack showing: motorized bike hub referenced as A, support frame overhang axle by 8″-10″ referenced as B, backpack frame referenced as C, adjustable shoulder strap referenced as D, handheld speed control & brake referenced as E, adjustable waist strap referenced as F, 30″ wheels 18″-24″ apart referenced as G, and load support referenced as I, in accordance with an embodiment of the present disclosure.

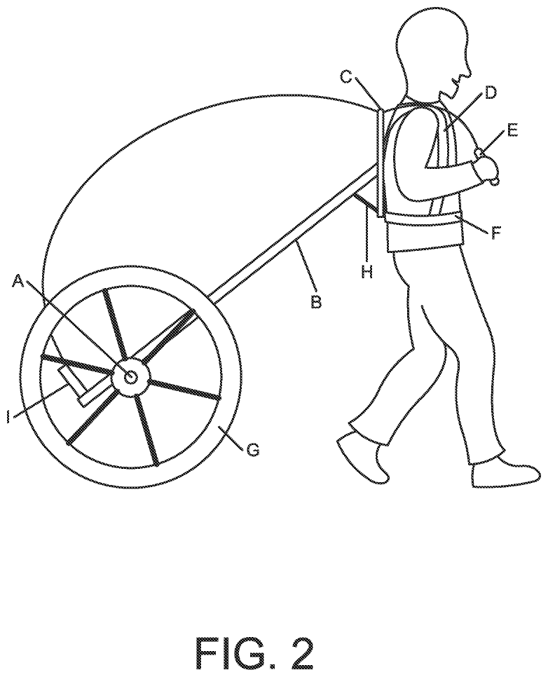

FIG. 2 is a side elevational view of the wheeled hiking backpack showing: motorized bike hub referenced as A, support frame overhang axle by 8″-10″ referenced as B, backpack frame referenced as C, adjustable shoulder strap referenced as D, handheld speed control & brake referenced as E, adjustable waist strap referenced as F, 30″ wheels 18″-24″ apart referenced as G, bracket to keep load distant from hiker feet referenced as H, and load support referenced as I, in accordance with an embodiment of the present disclosure.

The present disclosed motorized handcart backpack, aka also known as a wheeled hiking backpack, offers a modern accessory that distributes the load of a backpack evenly to allow for an improved and comfortable cargo and hiking experience, despite the common task of having to transport necessities. Expanding on the initial design of a backpack frame, the disclosure introduces a novel motorized bike hub that attaches to a backpack frame to make hiking substantially easier regardless of what is in tow. The trailing tires holds a significant portion of the weight of the pack which allows hikers to carry a larger load without undue stress or fatigue. To further enhance functionality, the motorized tires will help propel the load which ensures the hiker does not become overly wear carrying, or dragging, the heavier load over a prolonged hike. This innovative, top-quality product ensures a fully operational handcart hiking accessory that enhances the comfortability of an average hiking backpack and allows for the cargo carriage of larger loads with less stress on the hiker.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A handcart comprising:
a pair of two wheels each comprising a motorized electric hub;
a support frame attached to the pair of two wheels;
a backpack frame attached to the support frame;
a speed and brake controller attached to each of the motorized electric hubs.

2. The handcart of claim 1, further comprising an adjustable shoulder strap attached to the backpack frame.

3. The handcart of claim 1, further comprising an adjustable waist strap attached to the backpack frame.

4. The handcart of claim 1, further comprising a bracket configured to provide a separation between the backpack frame and the support frame for a movement of a person wearing the backpack frame.

5. The handcart of claim 1, further comprising a load support disposed across a back of the support frame and configured to prevent a load from falling off the back of the handcart.

6. The handcart of claim 1, wherein the speed and brake controller is hand held and attached to each of the motorized electric hubs.

7. The handcart of claim 1, wherein the speed and brake controller is wireless and in a wireless communication with each of the motorized electric hubs.

8. The handcart of claim 1, wherein a speed of each of the motorized electric hubs is set by the controller to be equal to a variable number adjustable by a person wearing the backpack frame.

9. The handcart of claim 1, wherein a speed of each of the motorized electric hubs is set separately by the controller to allow a turning of the handcart under a control of the speed and brake controller.

10. The handcart of claim 1, wherein a speed of each of the motorized electric hubs is proportional to a step size and step frequency of a person wearing the backpack frame.

11. The handcart of claim 1, wherein a torque of each of the motorized electric hubs is set by the controller to be equal to a variable torque adjustable by a person wearing the backpack frame.

12. The handcart of claim 1, wherein the speed and brake controller enables braking the pair of two wheels via a step assisted detection a person wearing the backpack frame has stopped stepping.

13. The handcart of claim 1, wherein the speed and brake controller enables a proportional braking the pair of two wheels to a step assisted detection a person wearing the backpack frame has slowed stepping.

14. The handcart of claim 1, wherein the backpack frame is reversibly attachable to a person wearing the backpack frame to be forward facing or rearward facing.

15. The handcart of claim 1, wherein the speed and brake controller senses a linear force applied parallel to a travel surface on the handcart and provides an electric torque on each of the pair of wheels proportional thereto via each of the motorized electric hubs.
